(19) United States
(12) Patent Application Publication
(10) Pub. No.: US 2004/0137637 A1
(43) Pub. Date: Jul. 15, 2004

(54) Breath gas analyzer for diagnosing diabetes and method of use thereof

(76) Inventors: Chuji Wang, Starkville, MS (US); M. John Plodinec, Starkville, MS (US)

Correspondence Address: Supervisor, Patent Prosecution Services, PIPER RUDNICK LLP, 1200 Nineteenth Street, N.W., Washington, DC, 20036-2412, US

(21) Appl. No.: 10/340,602

(22) Filed: Jan. 13, 2003

(51) Int. Cl. G01N 21/00

(52) U.S. Cl. 436/128; 422/84

(57) ABSTRACT

The present invention provides an apparatus to analyze breath gas for diagnosing diabetes. The apparatus determines acetone levels in breath gas samples and provides a diagnostic results based on the acetone levels. The present invention further provides a method of using such apparatus to distinguish healthy people and patients with early diabetes or sever diabetes.

### FIELD OF THE INVENTION

The present invention relates to absorption spectroscopy, and in particular, is directed to an apparatus combining pulsed laser light source and Cavity Ring-Down Spectroscopy to analyze breath gas for diagnosing diabetes.

### BACKGROUND OF THE INVENTION

Diabetes is a serious chronic illness that affects how the body uses food and is a life threatening human disease if not treated. About 17 million Americans, 6.2% of the population, have diabetes. While an estimated 11.1 million have been diagnosed, about 5.9 million people (one-third) are unaware that they have the disease. People with diabetes have insulin deficiency (type I) or insulin resistance (type ii). In both cases, patient's body uses fat instead of glucose (sugar) for energy. When the excessive glucose builds up in the blood, a chemical, acetone is formed in the blood. People with high levels of acetone in the body have acetone breath.

Methods generally used in the primary screen diagnostics of diabetes are urine sugar tests and fasting blood sugar levels tests. These tests are simple and high in specificity, but are low in sensitivity. In addition, the urine/blood sugar tests often give negative results to those who have early diabetes, so most patients with early diabetes are missed. Therefore, these tests are considered inadequate as screen test for diabetes [Sekikawa et al., Med Practice, 10:63 (1993)]. The glucose tolerance test is more accurate for diabetes diagnosis. However, the test has considerable side effects due to manipulation of large amount of glucose. It is also a painful and troublesome procedure requiring the restraint of patients and multiple blood sample collections. Recently, blood hemoglobin Alc (HBA1C) and fructosamine tests have been widely used in diabetes diagnosis [Kohno, et al., U.S. Pat. No. 5,916,538, (1999); Kohno, et al., U.S. Pat. No. 6,214,317 B1, (2001)]. These methods, however, become unreliable in the case of light diabetes since blood HBA1C and fructosamine levels would drop at the time of fasting. Furthermore, the test results can not be known until next visit to the hospital [Kohno et al., supra].

In sum, methods for diabetes diagnosis based on urine tests and blood tests generally have low sensitivity, bring side effects and pains to patients, and need sample (e.g. blood or urine) collections and long waiting time for testing results.

Since the time of Hippocrates in Ancient Greece, physicians have known that the aroma of human breath can provide clues to disease diagnosis. In Chinese traditional medicine, smelling diagnostics has always been one of the routine diagnoses of patients. The modern era of breath gas analysis has not commenced until in 1971, Linus Pauling, found that normal human breath contains more than 200 different volatile organic compounds (VOCs) in very low concentrations (most of them are in picomolar concentrations, around one part in a trillion). [Pauling et al., PNAS (USA), 68:2374, 1971].

Researchers suspected that some of these breath VOCs may be markers of diseases, but this theory made only slow progress because of two major technical problems: First, the concentrations of most breath VOCs are low, they can only be detected with sensitive laboratory instruments. Outside a research laboratory, there is no easy way to analyze breath VOCs. Secondly, even if the breath VOCs can be accurately analyzed, it is not yet clear what do they signify. Most breath VOCs are not even mentioned in modern textbooks of medicine or biochemistry.

It is widely known now that special odors of some breath gases are indicators of some specific diseases. For instance, the astute clinician is alert for the sweet, fruity odor of acetone in patients with uncontrolled diabetes, the musty, fishy reek of advanced liver disease, the urine-like smell that accompanies failing kidneys and the putrid stench of a lung abscess.

Nowadays analysis of breath gas may offer a noninvasive diagnostics for diabetes. A few recently invented methods are based on monitoring the ¹³CO₂ levels in breath to diagnose diabetes. In these methods, diagnostic agents such as ¹³C-glucose need to be labeled with known ¹³C levels and positioned in subjects [Kohno, et al., U.S. Pat. No. 5,916,538, (1999); Kohno, et al., U.S. Pat. No. 6,214,317 B1, (2001); Yatscoff, et al., WO 99/56790, (1999); Yatscoff, et al., U.S. Pat. No. 6,468,802 B1, (2002); and Yatscoff; et al., U.S. patent application 0042143 A1, (2002)]. These diagnostic agents need to be specially manufactured by pharmaceutical industries and to be prepared in forms such as oral tablets and capsules, or injection liquids. The dosage used for tests also depends on patient's age and body weight. Moreover, determination of ¹³C levels in exhaled CO₂ is commonly performed by rather expensive and sophisticated chromatography mass spectrometers (GC-MS).

As stated before, the blood with the dissolved acetone immediately participates in gas exchange and presence of acetone with high concentration levels in breath gas is indicative of diabetes. Directly monitoring acetone levels in breath gas would offer a simple, fast, and accurate method to diagnose diabetes. Analysis of breath gas is commonly performed with the help of GC-MS [Teranishi et al. Anal. Chem. 44:18, 1972]. Gas analysis based on GC-MS is sensitive and accuracy. However, GC-MS is expensive, complicated, and importable, thus it only limited to laboratory research. Recently, semiconductor gas sensors of portable sizes have been developed. The semiconductor sensors are capable of detecting acetone in exhalation with detection sensitivity up to hundreds ppb levels [Ryabtsev et al. Sensors and Actuators B 59:26, 1999], which are typical indicative levels of acetone in exhaled breath of patients suffering from severe diabetes. The limitation of semiconductor sensors is their low detection sensitivity. This kind of sensor is only applicable to diagnostics for serious diabetes and has no use in preventive diagnosis of early diabetes. In addition, because semiconductor sensors are based on electrical chemistry, they usually have low selectivity and are prone to false positives in diagnosis. Therefore, there still exist a need for an inexpensive, compact, and easy-to-use apparatus that can provide an accurate diagnosis of diabetes through a noninvasive procedure.

### SUMMARY OF THE INVENTION

The present invention provides a breath gas analyzer for diagnosing diabetes. Specifically, the breath gas analyzer measures the acetone level in breath gas of a subject and uses the acetone level as an indicator for diabetes diagnosis. The breath gas analyzer generally comprises a gas collector that collects a breath gas sample from a subject, a gas analyzer that measures the acetone levels in the breath gas sample by pulsed-cavity ring-down spectroscopy (pulsed-CRDS), and a controller/data processor that controls the breath gas analyzer and processes test data.

In a preferred embodiment, the gas analyzer comprises a light source that generates a laser beam, a tubular gas cell having a pair of high reflection mirrors on each end and a gas pressure and temperature sensor, a micro-pump, and a photodetector that detects the laser beam after it passes through the gas cell.

In another preferred embodiment, the controller/data processor is a computer and the test result is generated in real-time on the computer screen.

The present invention further provides a method of using the breath analyzer for the noninvasive diagnosis of diabetes. The method generally comprises the steps of collecting a breath gas sample, determining the acetone level in the breath gas sample using pulsed-CRDS, analyzing test data and providing a test result.

In a preferred embodiment, the breath gas sample is collected by having a test subject breathing directly into the breath gas collector (single or multiple breath), and the test result is provided as normal, early diabetes, or severe diabetes.

### DESCRIPTION OF THE FIGURES

FIG. 1 illustrates the schematic of the breath gas analyzer in the present invention.

FIG. 2 shows an embodiment of the breath gas analyzer in the present invention.

FIG. 3 is a flow diagram of a method for diagnosing diabetes using the breath gas analyzer of the present invention.

FIG. 4 shows the part of UV absorption spectra of acetone measured by pulsed-cavity ring-down spectroscopy for the first time. Measuring pressure is 1.5×10⁻³ torr, 300 ppmv (acetone saturated vapor bathed in argon gas at room temperature and atmospheric pressure). Overlapped parts show recorded spectra are repeatable. The spectra were not corrected to absorbance.

### DETAILED DESCRIPTION OF THE INVENTION

The following detailed description is presented to enable any person skilled in the art to make and use the invention. For purposes of explanation, specific nomenclature is set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

The present invention utilizes cavity ring-down spectroscopy (CRDS) [(O'Keefe A et al, Rev. Sci. Instrum, 59(12):2544-2551, (1988); Lehmann K, U.S. Pat. No. 5,528,040 (1996)] for the determination of acetone levels in gases containing detectable levels of acetone; in particular, in the breath gas. The presence of high acetone levels in breath gas is indicative of diabetes. CRDS, an ultra-sensitive laser absorption technique, is based upon a significantly different principle from traditional absorption spectral methods. In CRDS, absorption is measured via a change in the decay time for light trapped in an optical cavity rather than a change in intensity. Absolute absorption can be readily determined using CRDS and the performance of the technique is relatively unaffected by fluctuation noise of the pulsed laser source. Briefly, a laser beam is injected through one end mirror of the cavity where it remains trapped between the mirror surfaces. The intensity of the light in the cavity decays exponentially with time at a rate determined by the round trip losses experienced by the laser pulse. These losses are typically due to the finite reflectivity of the cavity mirrors, optical absorption, and/or scattering. The decay behavior can be monitored by a photomultiplier tube (PMT) located behind the second mirror. In the simple case of a low-pressure gas uniformly filling the cavity, the cavity loss originates predominantly from the mirrors and absorption of the sample based on the Beer-Lambert law. The time constant of the exponential decay or ring-down lifetime is given by:

$$τ = \frac{d}{c ( 1 - R + σ ( v ) nd )} \qquad ( 1 )$$

where, c is the speed of light, d is the cavity length, R is the reflectivity of the cavity mirrors, n is the sample density, and σ(v) is absorption cross-section at laser frequency n. The term σ(v)nd represents the single-pass absorbance of the sample in the cavity and is recognized as the exponent from the Beer-Lambert law. From equation (1), two clear advantages of CRDS are evident. First, determining the ring-down time constant allows for an absolute absorbance measurement without relative light intensities. Secondly, excellent absorbance detection limits at a few parts-per-million (ppm) fractional absorbance can be easily obtained with high reflectivity mirrors. Experimentally, the direct measurements are the ring-down lifetimes t and to with and without an absorber inside the cell/cavity. Thus, the absorbance can be rewritten as:

$$Absorbance = \frac{d}{c} ( \frac{1}{τ} - \frac{1}{{τ}_{0}} ) \qquad ( 2 )$$

CRDS has been used as diagnostic tool to measure species such as molecules, free radicals, molecular ions, and clusters under various experimental conditions including supersonic jet, flames, and plasmas [Busch et al. ed. ACS Symposium Series, pp720, Oxford University Press, 1999].

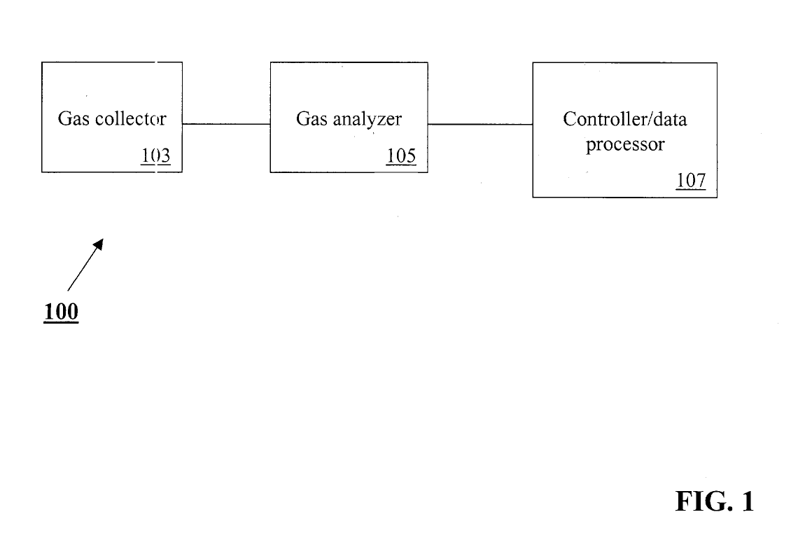

As shown in FIG. 1, an embodiment of the breath analyzer 100 of the present invention comprises a gas collector 103, a gas analyzer 105, and a controller/data processor 107. Briefly, the gas collector 103 collects a gas sample. The gas analyzer 105 determines the acetone level in the gas sample using the CRDS technology and generates testing data. The controller/data processor 107 controls the gas analyzer 105, processes the testing data, and provides the corresponding diagnostic result.

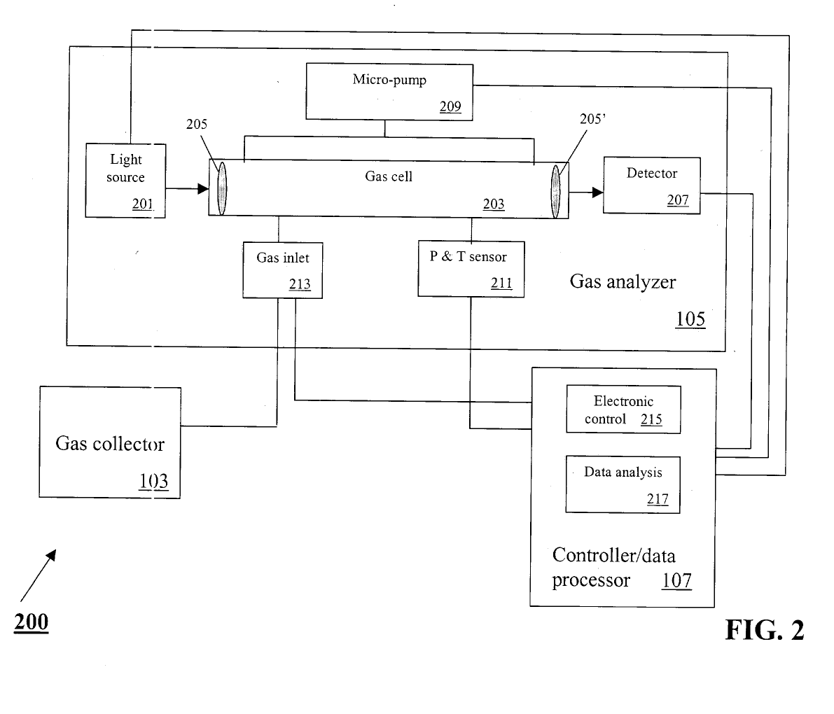

FIG. 2 depicts an embodiment of the breath gas analyzer 200 of the present invention in more detail. In this embodiment, acetone levels in the breath gas are determined by pulsed-cavity ring-down spectroscopy (pulsed-CRDS). Specifically, the gas analyzer 105 comprises a light source 201, a gas cell 203 which comprises a first end and a second end, a pair of high reflective mirrors 205 and 205′, a photodetector 207, a micro-pump 209, a pressure and temperature (P & T) sensor 211, and a gas inlet 213. The controller/data processor 107 comprises an electronic control portion 215 and a data analysis portion 217.

The light source 201 may be any pulsed UV laser light source with radiation within the range of 225-320 nm, preferably a compact and pulsed Nd:YAG laser with radiation at 266 nm. The gas cell 203 may have a length of between 30-100 cm, preferably 50 cm, and a diameter of between 1.5-3.0 cm, preferably 2.5 cm. The gas cell 203 is connected to the gas collector 103 through the gas inlet 213. The pair of high reflective mirrors 205 and 205′ are preferably mounted on each end of the gas cell 203. Alternatively, the high reflective mirrors 205 and 205′ may be replaced by a pair of prisms (not shown). The photodetector 207 is preferably a photovoltaic detector such as photodiodes or photomultiplier tubes (PMT). The micro-pump 209 may be any compact mechanical pump (for example, FV-10-1100, Advance Vanmp Tech, Inc.) that is capable of maintaining the gas pressure in the gas cell. The pressure and temperature sensor 211 measures the pressure and temperature of the breath gas in the gas cell and is electronically connected to the electrical control portion 215 of the controller/data processor 107, which is also electronically connected to the gas inlet 213. The electronic control portion 215 of the controller/data processor 107 measures and controls the gas pressure in the gas cell 203 through the pressure and temperature sensor 211 and the micro-pump 209, and provides ring-down even control. The data analysis portion 217 of the controller/data processor 107 processes ring-down data, determines acetone concentrations in the breath gas samples, and preferably, displays diagnostic results such as no diabetes, early diabetes, and severe diabetes. The controller/data processor 107 can be an integrated part of the breath analyzer 200. Alternatively, the controller/data processor 107 can be a detachable unit, such as a laptop computer loaded with ring-down software and electrical circuits.

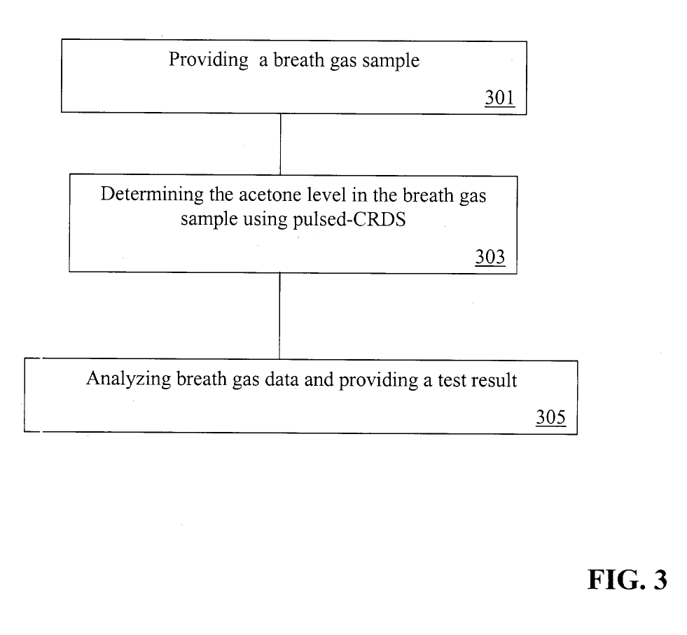

FIG. 3 provide a block diagram for a method 300 for diagnosing diabetes using the breath gas analyzer of the present invention. The method 300 comprises the steps of:

(1) Providing a Breath Gas Sample (Step 301)

In this step, a mammalian subject blow directly to the gas collector 103, and the breath gas sample is delivered at a proper time to the gas cell 203 through the gas inlet 213 and is controlled by the electronic control portion 215. The timing and the amount of gas delivery (single breath or multiple breath) is controlled by the electronic control portion 215 of the controller/data processor 107 electrical communication with 213.

(2) Determining the Acetone Level in the Breath Gas Sample Using Pulsed-CRDS (Step 303)

In this step, the light source 201, preferably a compact ND:YAG laser, generates a pulsed laser beam that bounces between the two high reflective mirrors (205 and 205′) back and forth and experiences thousands round trips within the gas cell 203. In each round trip, the laser beam leaks out a very small percentage through the rear mirror 205′ to the photodetector 207, which then generates a signal intensity decay curve that maps out the total photons' temporal behavior, or residence time (ring-down time) in the gas cell 203. The measurement is performed with or without the breath gas sample in the gas cell 203 and produces an empty ring-down time (with no breath gas sample in the gas cell 203) and a sample ring-down time (with the breath gas sample in the gas cell 203). Sample breath gas concentration is the derived from the ring-down time difference. The measurement procedures include the steps of follows:

(i) emptying the gas cell 203 using the micro-pump 209 and purging the gas cell 203 with room air to a constant measuring pressure, preferably, atmospheric pressure.

(ii) Measuring the empty ring-down time.

(iii) Emptying the gas cell 203 using the micro-pump 209 and introducing the sample gas into the gas cell 203 until the pressure inside the gas cell 203 reaches the constant measuring pressure, preferably, atmospheric pressure.

(iv) Measuring the sample ring-down time.

During the measurement, the gas pressures and temperatures in the gas cell 203 are read out by the pressure and temperature sensor 211, which is in electrical communication with the electronic control portion 215 of the controller/data processor 107. Each of the four steps can be finished within a few seconds.

Laser beam wavelength can be within the range of 225-320 nm. A preferred wavelength of 266 nm is chosen for two reasons. First, although acetone has strong spectral absorptions in the middle infrared (1R) spectral region (3000 cm⁻¹ and 1000 to 1800 cm⁻¹, attributed to C—H stretching and bending fundamentals, respectively), light sources capable of generating laser beams within this wave range are not fully commercially available or are functional only under cryogenic conditions, or both. These light sources with their control portion are large and very expensive, thus less practical in instrumentation. On the other hand, acetone has a rather large range of UV absorption which extends from 225 to 320 nm. Within this spectral region, light source of single UV frequency, with pulsed output at 266 nm from a fourth frequency generation of a compact Nd: YAG laser, is commercially available (for example, Crystalaser, Inc., New Wave Research, Inc.). This miniature and inexpensive Nd:YAG (266 nm) laser is the ideal light source for breath analyzer using pulsed-CRDS technology. The acetone absorption cross-section at 266 nm (at room temperature and 1 atm) documented in literatures is 4.5×10⁻²⁰ cm² [Thurber et al. Applied Optics, 37:4963, (1998)]. At room temperature and atmospheric pressure, the absorption spectrum reveals a broadband with a peak near 265 nm. At low temperatures and pressures, the absorption spectrum shows well-resolved vibrational structures attributed to S₁-S₀ electronic transition.

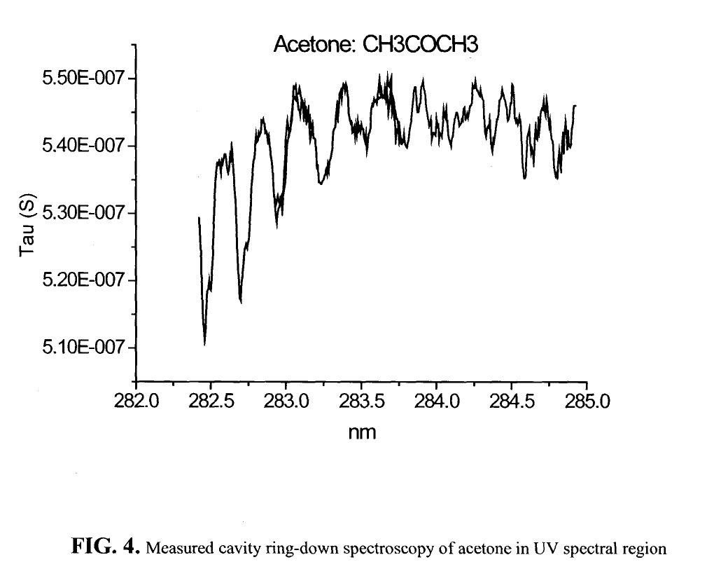

FIG. 4 shows the part of UV absorption spectra of acetone was measured by pulsed-CRDS for the first time around 282 nm at room temperature and low pressure (1.5×10⁻³ torr), 300 ppmv under static conditions. The ring-down spectrum shows clearly resolved vibronic band features with strongest absorption near 282 nm at this measuring range (282 to 285 nm). This spectra of acetone also can be extended to short wavelength region that covers the 266 nm wavelength used in the present invention.

The second reason is that breath gas typically contains more than 200 VOCs. To avoid background noise, it is critical to choose a diagnostic wavelength for acetone that is not interfered by the absorptions of other VOCs. Most common VOCs, such as CO, CO₂, NOx, O₂, and H₂O, have strong absorptions in the middle IR spectral region, attributed to their fundamental transitions. However, these VOCs usually have no absorption in the this UV range. Therefore, the spectral transitions that are attributed to electronic transitions, such as the S₁-S₀ transition of acetone at 266 nm, is an ideal wave length for acetone detection with little interference from other VOCs.

(3) Analyzing Breath Gas Data and Providing a Testing Result (step 305)

In this step, the data analysis portion 217 of the controller/data processor 107 analyzes the testing data generated in step 303 and produces a test result. The test result may be provided in various format including visual and audio means. The test result may be presented simply as the acetone concentration of the breath gas sample, or in a diagnostic form such as no diabetes (e.g. breath gas acetone level (BGAL) is less or equal to 40 ppb), early diabetes (e.g. BGAL is more than 40 ppb and less than 200 ppb) or severe diabetes (e.g. BGAL can be hundreds up ppb). [“Agency of Toxic Substances and Disease Registry Toxicological Profiles”, CRC Press LLC, (1999)].

In a preferred embodiment, the whole system is controlled by a computer, preferably, a laptop computer. Testing data are analyzed and corresponding diagnostic conclusions are displayed on the computer screen. The test data or test results are saved with testing dates and patient's I.D. for the future comparisons.

The measurement of acetone by the breath analyzer of the present invention using pulsed-CRDS is highly sensitive. Based on CRDS measurement principle, equation (1) and (2), the relation between minimum detectable absorbance and physical parameters of a CRDS setup is given by

$$Absorbance = σ nd = ( 1 - R ) \frac{Δτ}{τ} \qquad ( 3 )$$

where, s, n, d, and R are absorption cross-section, gas density of absorbers, length of gas cell, and mirror reflectivity, respectively; t is the ring-down time with absorbers, and Δτ is the difference between t₀ (without absorbers) and t. Given a typical reflectivity of ring-down mirrors at 266 nm 99.99%,

$$\frac{Δτ}{τ} ∼ {10}^{- 3} ,$$

gas cell length 50 cm, at room temperature and 1 atmospheric pressure, the limit of detection (LoD) of acetone will be 1.8 parts-per-billion (ppb) by volume. With a better mirror reflectivity and lower measuring pressure, LoD can be easily improved to hundreds parts-per-trillion (ppt) levels. Note that acetone concentrations in exhalation of severe diabetes, urban atmosphere, and drinking water are hundreds ppb, 7-8 ppb, and 1 ppb, respectively.

Another significant merit of the breath gas analyzer of the present invention is the non-spectral interference for breath gas diagnostics. As discussed earlier, the pulse-CRDS technology allows the breath gas detector to use a diagnostic wavelength (e.g. 266 nm) that is free of interference from common VOCs in the breath gas.

Moreover, the breath gas analyzer of the present invention provides noninvasive procedure for the diagnosis of diabetes. The analyzer requires no sample preparation and produces real-time result for single breath test or multiple breath test. Since the CRDS breath gas analyzer uses spectral fingerprints to identify the acetone molecules, it is highly selective and therefore generates no false alarm in diagnosis. In addition, the apparatus is inexpensive, portable, and easy to use. It is capable of distinguishing healthy persons from patients with early diabetes or severe diabetes, and can be setup in a variety of locations including public facilities for a quick screen of diabetes.

The preferred embodiments of the breath gas analyzer of the present invention are intended to be illustrative and not limiting. Modifications and variations can be made by persons skilled in the art in light of the above teachings. It is also conceivable to one skilled in the art that the present invention can be used for other purposes of measuring the acetone level in a gas sample, e.g. for monitoring air quality. Therefore, it should be understood that changes may be made in the particular embodiments disclosed which are within the scope of what is described as defined by the appended claims.

What is claimed is:

1. An apparatus for diagnosing diabetes comprising:
(1) a gas collector,
(2) a gas analyzer connected to said gas collector through a gas inlet, wherein said gas analyzer comprises:
a gas cell having a first end and a second end;
a pulse UV light source at the first end of said gas cell, wherein said UV light source provides a laser radiation to said gas cell;
a detector at the second end of said gas cell, said detector measures the laser radiation and generates a corresponding signal, and
(3) a controller/data processor that controls said gas analyzer and processes test data.

2. The apparatus according to claim 1, wherein said gas collector is a breath gas collector.

3. The apparatus according to claim 2, wherein said apparatus measures an acetone level in breath gas and uses said acetone level as an indicator for diabetes diagnosis.

4. The apparatus according to claim 1, wherein said pulsed UV light source comprises a compact and pulsed Nd:YAG laser.

5. The apparatus according to claim 1, wherein said pulsed UV light source produces a laser beam having a wavelength in a range of 225-320 nm.

6. The apparatus according to claim 5, wherein said laser beam has a wavelength of 266 nm.

7. The apparatus according to claim 1, wherein said gas cell comprises a pair of high reflective mirrors that are mounted on each end of said gas cell.

8. The apparatus according to claim 1, wherein said gas cell comprises a pair of prisms that are mounted on each end of said gas cell.

9. The apparatus according to claim 1, wherein said gas analyzer further comprises a pressure and temperature sensor to measure gas pressure and temperature inside said gas cell.

10. The apparatus according to claim 9, wherein said pressure and temperature sensor is electronically connected to said controller/data processor.

11. The apparatus according to claim 1, wherein said detector is a photodetector.

12. The apparatus according to claim 11, wherein said photodetector is a photovoltaic detector and is selected from the group consisting of photodiodes and photomultiplier tubes (PMT).

13. The apparatus according to claim 1, wherein said gas cell has a length between 30-100 cm.

14. The apparatus according to claim 13, wherein said gas cell has a length of 50 cm.

15. The apparatus according to claim 1, wherein said gas cell has a diameter between 1.5-3.0 cm.

16. The apparatus according to claim 15, wherein said gas cell has a diameter of 2.5 cm.

17. The apparatus according to claim 1, further comprising a micro-pump to control a gas pressure in said gas cell.

18. The apparatus according to claim 17, wherein said micro-pump is a small mechanical pump.

19. The apparatus according to claim 1, wherein said controller is an electronic controller and controls said gas inlet.

20. An apparatus for diagnosing diabetes comprising:
(1) a breath gas collector for collecting breath gas of a subject,
(2) a gas analyzer connected to said breath gas collector through a gas inlet, wherein said gas analyzer comprises:
a gas cell having a first end and a second end;
a pulsed UV light source at the first end of said gas cell, wherein said pulsed UV light source produces a laser radiation with a wavelength of 266 nm;
a pressure and temperature sensor that measures gas pressure and temperature in said gas cell;
a micro-pump that controls gas pressure in said gas cell;
a photodetector at the second end of said gas cell, said photodetector measures the laser radiation and generates a corresponding signal, and
(3) controller/data processor for controlling said gas inlet and said gas analyzer, and process test data.

21. The apparatus according to claim 20, wherein said apparatus measures an acetone level in breath gas and uses said acetone level as an indicator for diabetes diagnosis.

22. The apparatus according to claim 21, wherein said gas cell comprises a pair of high reflective mirrors that are mounted on each end of said gas cell.

23. The apparatus according to claim 20, wherein said gas cell comprises a pair of prisms that are mounted on each end of said gas cell.

24. The apparatus according to claim 20, wherein said photodetector is a photovoltaic detector and is selected from the group consisting of photodiodes and PMT.

25. The apparatus according to claim 20, wherein said gas cell has a length between 30-100 cm.

26. The apparatus according to claim 25, wherein said gas cell has a length of 50 cm.

27. The apparatus according to claim 20, wherein said gas cell has a diameter between 1.5-3.0 cm.

28. The apparatus according to claim 27, wherein said gas cell has a diameter of 2.5 cm.

29. A method for screening a mammalian subject to determine whether said subject should be treated for diabetes, said method comprising the steps of:
(1) collecting a breath gas sample from said subject,
(2) determining an acetone level in said breath gas sample using ring-down spectroscopy (CRDS), and
(3) correlating said acetone level in said breath gas with a standard, wherein said acetone level in said breath gas above a standard level indicates said subject may be diabetes.

30. The method of claim 29, wherein said acetone level in said breath gas sample is determined using pulsed cavity ring-down spectroscopy (pulsed-CRDS).

31. The method of claim 29, wherein said acetone level in said breath gas sample is determined using pulsed-CRDS with a UV light source produces a laser radiation having a wavelength between 225-320 nm.

32. The method of claim 31, wherein said UV light source has a wavelength of 266 nm.

33. The method of claim 29 further comprising the steps of:
(i) measuring an empty ring-down time in the presence of room air to obtain a baseline;
(ii) measuring a sample ring-down time in the presence of said breath gas; and
(iii) determining the acetone level in said breath gas sample based on a difference between the empty ring-down time and the sample ring-down time.
